(19) United States
(12) Patent Application Publication
(10) Pub. No.: US 2011/0006014 A1
(43) Pub. Date: Jan. 13, 2011

(54) System and Method For Process and Waste Water Filtration

(75) Inventors: Joseph F. Scalise, Chandler, AZ (US); Lawrence El-Hindi, Dewitt, NY (US); Thomas B. Horn, New Hartford, NY (US)

Correspondence Address: BOND, SCHOENECK & KING, PLLC, ONE LINCOLN CENTER, SYRACUSE, NY, 13202-1355, US

(73) Assignee: FILTERTECH, INC., Manlius, NY (US)

(21) Appl. No.: 12/499,567

(22) Filed: Jul. 8, 2009

(51) Int. Cl. C02F 1/52; B01D 35/157

(52) U.S. Cl. 210/738; 210/206; 210/88

(57) ABSTRACT

A system and method for filtering caster rinse water. A flocculating agent is added to caster rinse water and the mixture is agitated first at high-speed and then at low-speed to promote flocculation. The flocked solids are removed from the caster rinse water using a filtration unit and the filtered water is stored for reuse.

### CLAIM OF PRIORITY

The present application claims priority to U.S. Provisional Application Ser. No. 60/078,965, filed Jul. 8, 2008, the entirety of which is hereby incorporated by reference.

### BACKGROUND OF THE INVENTION

1. Field of the Invention

The present invention relates to a system and method of filtering water or waste water used in an industrial process, and, more particularly, to a system and method for filtering impurities out of process and waste/caster water.

2. Description of the Related Art

Molten metal is cast into finished or semi-finished shapes such as slabs, blooms, billets, wire, or rods by a variety of means. One method commonly used for casting of metal is the continuous cast method. Using the continuous cast method, molten metal such as copper or aluminum is poured onto a caster wheel or dam blocks and formed into a bar.

To protect the caster wheel or dam blocks against the high temperature of the molten metal, a layer of thermal insulation is applied. The insulation is commonly a carbon or hydrocarbon compound such as soot, graphite, carbon black, or oil. The thermal insulator also acts as a mold release allowing the cooling metal to separate from the caster wheel or dam blocks.

Once the metal bar is formed, it is then cooled with rinse water before it is sent for further processing such as being rolled into rod. This rinse water becomes contaminated with the carbon or hydrocarbon material which was applied to the caster wheel or dam blocks and results in dirty rinse water, reduced life of the caster wheel or dam blocks, increased maintenance for heat exchangers and cooling towers, and lost production.

Casting facilities typically send a large portion of the caster rinse water to the drain or to waste treatment because it is exceptionally difficult to filter the rinse water due to the extremely fine sub-micronic particulate size of the carbon material. These facilities also augment the caster water supply with fresh water to dilute the carbon material concentration. High concentration of the carbon material in the caster rinse water causes plugging and fouling of heat exchangers and cooling towers. Disposal of contaminated caster rinse water increases sewer discharge fees or water treatment costs, and diluting the rinse water with fresh water increases water usage thus incurring additional cost.

It is therefore a principal object and advantage of the present invention to provide a method for the filtration of process and waste/caster rinse water.

It is another object and advantage of the present invention to lower overall water consumption during casting by reusing filtered process and waste/caster rinse water.

It is a further object and advantage of the present invention to lower costs associated with water consumption and disposal of contaminated process and waste/caster rinse water.

It is also an object and advantage of the present invention to reduce secondary costs associated with the use of contaminated water such as increased wheel or dam block maintenance and replacement, as well as increased maintenance of heat exchangers and cooling towers.

### SUMMARY OF THE INVENTION

A method for filtering process and waste/caster water, the method comprising one or more of the steps of: (1) pumping process and waste/caster rinse water into a mixing tank; (2) adding flocculating agent to the mixing tank; (3) mixing the process and waste/caster water and the flocculating agent with a high-speed mixer; (4) mixing the process and waste/caster water and the flocculating agent with a low-speed mixer; (5) transferring the mixture to a filtration unit; and (6) filtering the flocked solids from the water on a continuous basis.

A system for filtering caster water, the system comprising: (1) a first mixing tank into which process and waste/caster rinse water is pumped; (2) a flocculating agent which is fed into the first mixing tank and which is optionally stored in a floor-mounted feeder; (3) a high-speed mixer in the first mixing tank that combines the process and waste/caster rinse water and the flocculating agent; (4) a second mixing tank into which the mixture of process and waste/caster rinse water and flocculating agent is fed; (5) a low-speed mixer in the second mixing tank that further agitates the mixture; (6) a filtration unit to filter the flocked solids; and (6) a process and waste/caster water reservoir tank for storage of filtered process and waste/caster water.

### BRIEF DESCRIPTION OF THE DRAWINGS

The present invention will be more fully understood and appreciated by reading the following Detailed Description in conjunction with the accompanying drawings, in which:

FIG. 1 is a flowchart showing an example overview of a method for filtering process and waste/caster water according to the present invention.

FIG. 2 is a schematic representation of a filtration system using the present invention.

### DETAILED DESCRIPTION OF THE INVENTION

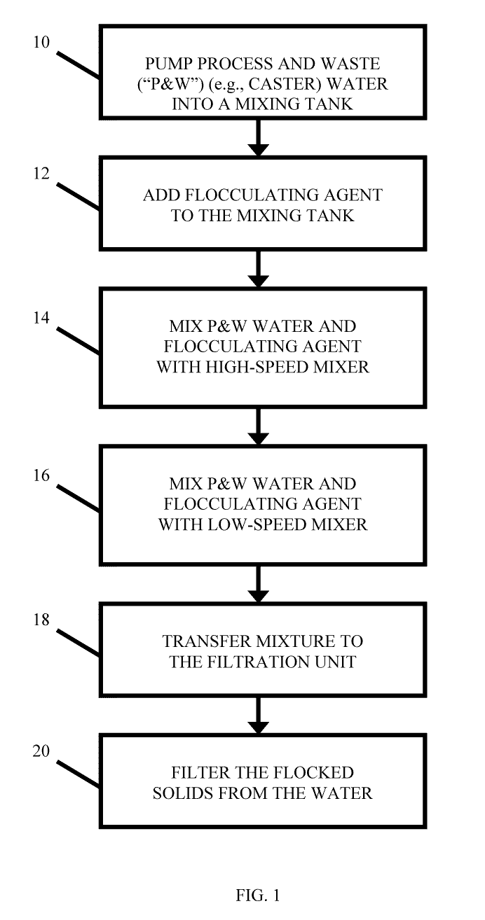

Referring now to the drawings, there is seen in FIG. 1 a flowchart showing an example overview of a method for filtering water used in an industrial process, for example, caster water, according to the present invention (the process and system will be referred to herein as applying to caster water with the understanding that its application extends to filtration of water in other types of industrial processes). As an initial step 10, process and waste (“p&w”) (e.g., caster) rinse water is pumped into a mixing tank. In one embodiment of the present invention, the mixing tank is specifically sized and designed for the flow rate of the water to be treated. Additionally, the contaminated p&w/caster rinse water can be pumped with an optional feed pump, and the water flow rate into the mixing tank can be measured with an optional flow meter.

In step 12, a flocculating agent is added to the mixing tank. The flocculating agent can be stored in a floor-mounted feeder before being transferred to a solids feeder for introduction to the mixing tank, or can be introduced using a solids conveyor or a gravity feeder. The flow-rate of the flocculating agent can be adjusted based on the flow-rate of the p&w/caster rinse water into the system. The flocculating agent can be any agent that causes accumulation, clumping, or flocculation of the p&w/caster water contaminants such that they may be filtered out of the water. In a preferred embodiment, the flocculating agent is bentonite or a bentonite-containing mixture, although other flocculating agents could also be used.

To promote and maximize interaction between the p&w/caster water contaminants and the flocculating agent, the mixture is agitated in the mixing tank using a high-speed mixer in step 14.

In step 16, the mixture is transferred to a flocculation tank and mixed using a low-speed mixer. Both the high-speed mixer in step 14 and the low-speed mixer in step 16 can be specially-designed to minimize size reduction of the developing floc particles, including utilizing low-shear impellers. Although flocculation is encouraged through two steps using two separate tanks in the preferred embodiment, both steps can be carried out in a single tank. Under this arrangement, the mixture of caster water and flocculating agent would be mixed in batches, first at high speed and then at low speed.

Once the flocculating agent and the p&w/caster water are completely mixed and sufficient flocculation has occurred, the p&w/caster water is transferred to a filtration unit in step 18. The filtration unit can employ any filtration system, including gravity or vacuum filtration. In the preferred embodiment, the p&w/caster water overflows by gravity into a gravity filtration unit such as Filtertech's Model HGF “High Performance” Deep Bed Gravity Filter with a specially designed inlet distribution header to further enhance separation of the floc material.

In step 20, the flocked solids are filtered from the p&w/caster water. Using the Filtertech Deep Bed Gravity Filter, the flocked solids accumulate on the surface of the filtration medium to form a filter “cake’ as the water passes through the filter by gravity. As the filter cake becomes thicker and more dense, the filtration rate decreases and the water level begins to rise. A multi function level control float then automatically indexes the dirty filtration medium out of the filtration unit and introduces unused filtration medium into the unit.

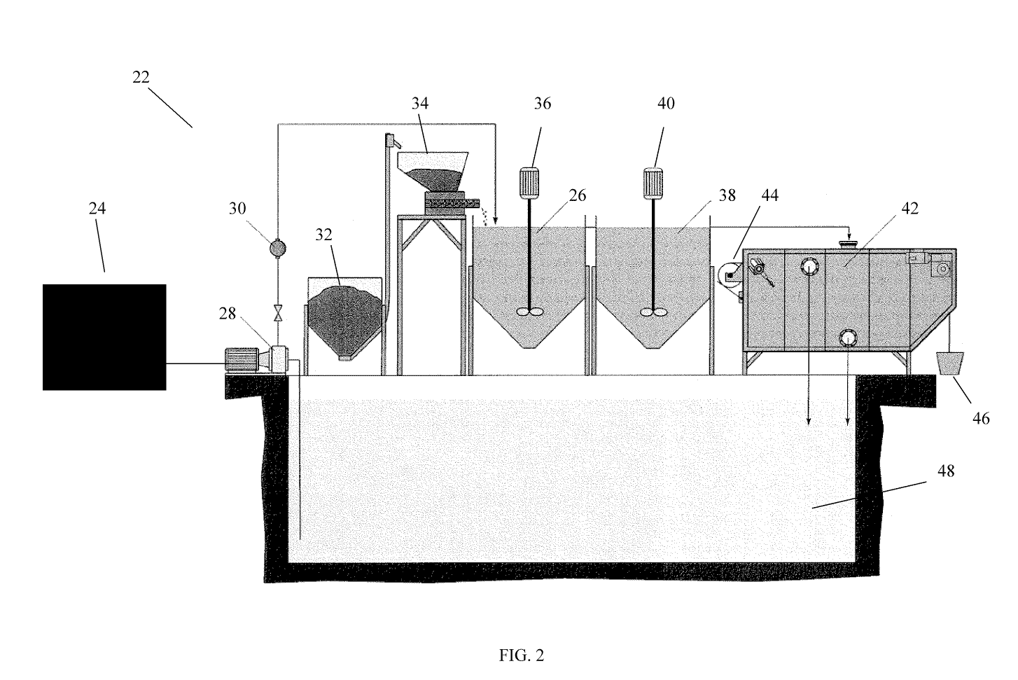

FIG. 2 is a schematic representation of a p&w/caster rinse water filtration system using the present invention. The system 22 begins with the use of filtered or fresh water to rinse carbon-based thermal insulator from formed metal and the caster wheel during the continuous casting process 24. The dirty p&w/caster rinse water is then pumped into a mixing tank 26 using a feed pump 28, with the rinse water flow rate optionally measured by a flow meter 30.

A flocculating agent is continuously fed into mixing tank 26. The flocculating agent is stored in an optional floor-mounted feeder 32 before it is transferred to a solids feeder 34 (of which there may be one or many) and fed into the mixing tank. One of the benefits of storing the flocculating agent in a floor-mounted feeder or a bulk solids hopper is that the agent will only need periodic replenishing, thereby reducing maintenance and labor costs. Additionally, a variable speed drive adjusts the feed rate of the flocculating agent to coincide with changes in the flow rate of caster rinse water to the system. In a preferred embodiment, about 10 pounds of flocculating agent is used per day, with approximately 25 gallons of water being processed per minute. The precise parameters of the amount of agent used and in what ratios and at what speeds is governed by the kind of dry chemistry and on the type of water being filtered (e.g., Meitler Consulting, Inc. of Kansas City, Kans. publishes such data).

The p&w/caster rinse water and the flocculating agent are mixed using a high-speed mixer 36. Once the agent and water are sufficiently combined, a resident time of about five minutes for example, the mixture is pumped or gravity fed into a second floc tank 38 and mixed using a low-speed mixer 40. Tanks 26 and 38 can be, for example, 225 gallon tanks. Additionally, both high-speed mixer 32 and low-speed mixer 36 can be specially-designed to minimize size reduction of the developing floc particles.

Once the flocculating agent and the p&w/caster rinse water are completely mixed and sufficient flocculation has occurred, the mixture is transferred to a filtration unit 42. The mixture can be pumped into the filtration unit, such as a vacuum filter or flat bed filter, or fed by gravity overflow, among other methods. FIG. 2 shows an example of a gravity filtration unit, specifically the Filtertech Model HGF “High Performance” Deep Bed Gravity Filter. Unused filtration medium 44 is fed as needed into the filtration unit, and dirty filtration medium 46 feeds out of the unit for disposal. The filtered p&w/caster water enters a p&w/caster water reservoir tank 48 for later reuse.

The present invention has been shown to successfully filter p&w/caster rinse water. For example, one study of the system showed a reduction in the turbidity of caster water from greater than 4000 Nephelometric Turbidity Units (NTU) before filtration to less than 120 NTU after filtration.

What is claimed is:

1. A system for filtering water used in an industrial process, comprising:
a. a reservoir for containing dirty caster rinse water;
b a mixing tank in fluid communication with said reservoir;
c. a supply for flocculating agent;
d. a first mixer adapted to mix the dirty caster rinse water and flocculating agent in said mixing tank to produce a floc mixture;
e. a floc tank positioned in fluid communication with said mixing tank and adapted to contain the mixture of the dirty caster rinse water and flocculating agent; and
f. a second mixer adapted to mix the floc mixture; and
g. a filtration unit positioned in fluid communication to said floc tank.

2. The system according to claim 1, further comprising a feed pump that provides the motive force for transferring the dirty caster rinse water to said mixing tank.

3. The system according to claim 2, further comprising a flow meter positioned in the flow path of the dirty caster rinse water as it is pumped into said mixing tank.

4. The system according to claim 1, wherein said supply for flocculating agent is contained in a solids feeder positioned in communication with said mixing tank.

5. The system according to claim 4, further comprising a floor-mounted feeder adapted to contain a supply of flocculating agent and positioned in fluid communication with said solids feeder.

6. The system according to claim 5, further comprising a variable speed drive adapted to adjust the feed rate of the flocculating agent.

7. The system according to claim 6, wherein said variable speed drive is selectively adapted to adjust the feed rate of the flocculating agent to coincide with the flow rate of the dirty caster rinse water.

8. The system according to claim 1, wherein said first mixer is adapted to operate at a higher rate of speed than said second mixer.

9. A method for filtering water used in an industrial process, comprising the steps of:
a. pumping waste water into a tank;
b. adding flocculating agent to the mixing tank
c. mixing the waste water and flocculating agent at a first rate of speed;
d. mixing the waste water and flocculating agent at a second rate of speed less than the first rate of speed, thereby creating a mixture of flocked solids and water;
e. transferring the mixture of waste water and flocculating agent to a filtration unit; and
f. filtering the flocked solids from the water.

10. A system for filtering water used in an industrial process, comprising:
a. a reservoir for containing dirty caster rinse water;
b a mixing tank in fluid communication with said reservoir;
c. a supply for flocculating agent;
d. a first mixer adapted to mix the dirty caster rinse water and flocculating agent in said mixing tank to produce a floc mixture;
e. a second mixer adapted to mix the floc mixture; and
g. a filtration unit positioned in fluid communication to said mixing tank.

11. The system according to claim 10, further comprising a feed pump that provides the motive force for transferring the dirty caster rinse water to said mixing tank.

12. The system according to claim 11, further comprising a flow meter positioned in the flow path of the dirty caster rinse water as it is pumped into said mixing tank.

13. The system according to claim 10, wherein said supply for flocculating agent is contained in a solids feeder positioned in communication with said mixing tank.

14. The system according to claim 13, further comprising a floor-mounted feeder adapted to contain a supply of flocculating agent and positioned in fluid communication with said solids feeder.

15. The system according to claim 14, further comprising a variable speed drive adapted to adjust the feed rate of the flocculating agent.

16. The system according to claim 15, wherein said variable speed drive is selectively adapted to adjust the feed rate of the flocculating agent to coincide with the flow rate of the dirty caster rinse water.

17. The system according to claim 10, wherein said first mixer is adapted to operate at a higher rate of speed than said second mixer.
